(19) United States
(12) Patent Application Publication
(10) Pub. No.: US 2025/0369781 A1
(43) Pub. Date: Dec. 4, 2025

(54) OPTICAL TEMPERATURE SENSOR

(71) Applicant: Futaba Corporation, Chiba-ken (JP)

(72) Inventors: Ryosuke INADOME, Chiba-ken (JP); Takashi INOUE, Chiba-ken (JP); Yutaka KAYANO, Chiba-ken (JP)

(73) Assignee: Futaba Corporation, Chiba-ken (JP)

(21) Appl. No.: 19/197,058

(22) Filed: May 2, 2025

(30) Foreign Application Priority Data
May 31, 2024 (JP) 2024-089108

(51) Int. Cl. G01D 5/353; G01K 11/32

(52) U.S. Cl. CPC G01D 5/35374; G01K 11/32

(57) ABSTRACT

An optical temperature sensor includes a cylindrical fiber probe into which an optical fiber is threaded, and a protective window that is formed of sapphire and positioned on the distal end side of the fiber probe. The surface of the protective window opposite to the optical fiber in the axial direction of the fiber probe is formed as a first surface, the surface of the protective window facing the optical fiber is formed as a second surface, and the first surface is an a-face of the sapphire.

### CROSS-REFERENCE TO RELATED APPLICATIONS

This application claims the priority benefit of Japanese Patent Application No. 2024-089108, filed on May 31, 2024. The entirety of the above-mentioned patent application is hereby incorporated by reference herein and made a part of this specification.

### TECHNICAL FIELD

The present disclosure relates to the technical field of optical temperature sensors using optical fibers.

### BACKGROUND

Some optical temperature sensors measure the temperature and the like of a measurement target by transmitting infrared light emitted from the measurement target to a detector through an optical fiber (refer to Japanese Unexamined Patent Application Publication No. 2008-232753, for example). The optical temperature sensor described in Japanese Unexamined Patent Application Publication No. 2008-232753 is used in a molding machine that molds resin molded products, and measures the temperature and pressure of molten resin in a cavity or the like by connecting a fiber probe through which an optical fiber is threaded into the cavity or the like.

Among optical temperature sensors as described above, there is one that is provided with a protective window at the distal end of the fiber probe to protect the fiber probe (optical fiber) (refer to Japanese Unexamined Patent Application Publication No. H1-124725, for example). In the optical temperature sensor described in Japanese Unexamined Patent Application Publication No. H1-124725, the protective window is made of sapphire.

### SUMMARY

Optical temperature sensors as described above are sometimes used in high-temperature and high-pressure environments, such as the nozzle of an injection molding machine, for example. In such high-temperature environments, the pressure resistance of the protective window may decrease compared to normal temperature environments, and there is a risk that the protective window may be damaged by pressure.

In view of this, an object of the present disclosure is to prevent damage to the protective window.

An optical temperature sensor according to the present disclosure includes a cylindrical fiber probe into which an optical fiber is threaded, and a protective window that is formed of sapphire and positioned on the distal end side of the fiber probe. The surface of the protective window opposite to the optical fiber in the axial direction of the fiber probe is formed as a first surface, the surface of the protective window facing the optical fiber is formed as a second surface, and the first surface is an a-face of the sapphire.

Accordingly, the maximum compressive stress of the protective window in a high-temperature environment is unlikely to decrease compared to that in a normal temperature environment.

According to the present disclosure, the maximum compressive stress of the protective window in a high-temperature environment is unlikely to decrease compared to that in a normal temperature environment, so that it is possible to prevent damage to the protective window by pressure during measurement.

### BRIEF DESCRIPTION OF DRAWINGS

FIG. 1 illustrates a first embodiment of the present disclosure together with FIGS. 2 and 4, and this figure is a cross-sectional view of an optical temperature sensor.

FIG. 2 is an enlarged cross-sectional view illustrating a part of the optical temperature sensor.

FIG. 3 is a diagram for describing crystal faces of sapphire.

FIG. 4 is a diagram illustrating results of a test on the pressure resistance of protective windows.

FIG. 5 is an enlarged cross-sectional view of an optical temperature sensor according to a second embodiment.

FIG. 6 is an enlarged cross-sectional view of an optical temperature sensor according to a third embodiment.

FIG. 7 is an enlarged cross-sectional view of an optical temperature sensor according to a fourth embodiment.

### DETAILED DESCRIPTION

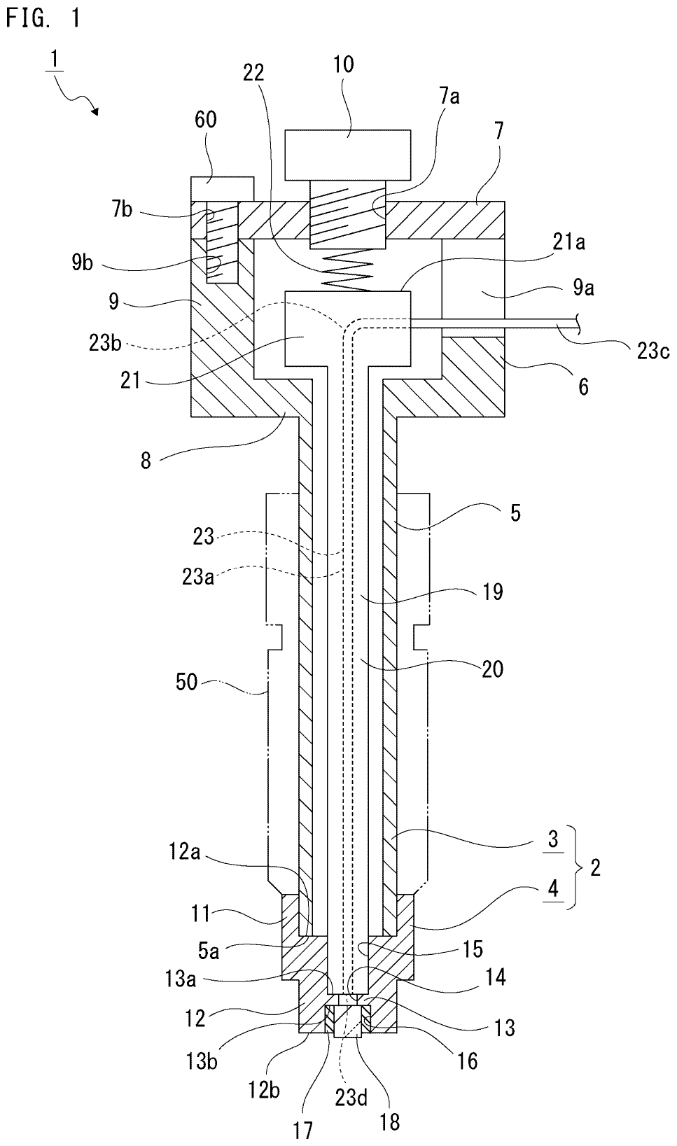

Hereinafter, embodiments of an optical temperature sensor according to the present disclosure will be described with reference to the accompanying drawings (see FIGS. 1 to 7).

Note that the optical temperature sensor described below has a tubular fiber probe, and in the following description, the axial direction of the fiber probe is referred to as the up-and-down direction, and the distal end side of the fiber probe is referred to as the downward direction to show the up, down, left, and right directions. However, the up, down, left, and right directions described below are for convenience of explanation and are not limited to these directions with respect to the implementation of the present disclosure.

### <Optical Temperature Sensor According to First Embodiment>

First, an optical temperature sensor 1 according to a first embodiment will be described (see FIGS. 1 to 3).

The optical temperature sensor 1 is attached to an injection molding machine (not illustrated), for example, and is used to measure the temperature of molten resin in the nozzle, for example. The optical temperature sensor 1 may be attached to various molding machines other than injection molding machines, such as extrusion molding machines and blow molding machines.

The optical temperature sensor 1 is configured such that each required section is disposed or supported in an outer casing 2 (see FIG. 1). The outer casing 2 has a housing 3 and a window supporting section 4. Each section of the outer casing 2 is formed from a metal material, for example.

The housing 3 has a shaft 5, a disposing section 6 and a lid section 7.

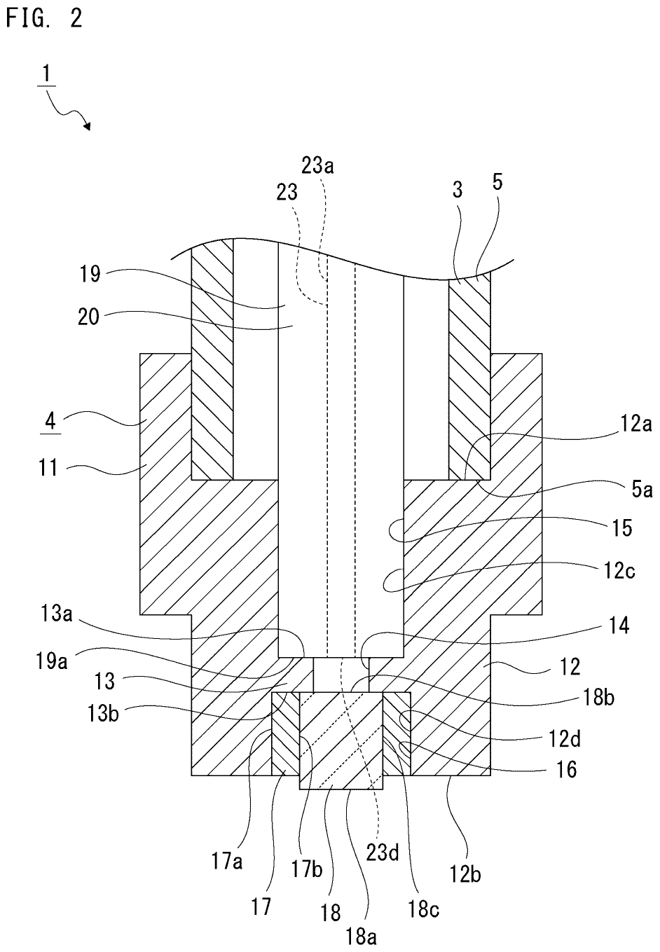

The shaft 5 is formed in a cylindrical shape with its axial direction in the up-and-down direction. A mounting nut 50 for mounting the optical temperature sensor 1 on the injection molding machine is fitted on a portion of the shaft 5 except for both upper and lower end portions. A lower end surface of the shaft 5 is formed as a pressing surface 5a (see FIGS. 1 and 2).

The disposing section 6 has a flange section 8 extending outward from an upper end portion of the shaft 5 and a ring section 9 having an approximately cylindrical shape that protrudes upward from an outer circumference portion of the flange section 8. The disposing section 6 is, for example, formed integrally with the shaft 5. The ring section 9 has a notch 9a that is open upward and that radially penetrates. A plurality of fitting holes 9b that are open upward and that are spaced out in the circumferential direction are formed in an upper end portion of the ring section 9.

The lid section 7 is formed in a ring shape and has a screw hole 7a in its center. An adjustment screw 10 is screwed into the screw hole 7a. Screw threading holes 7b that penetrate in the up-and-down direction and that are spaced out in the circumferential direction are formed in an outer circumference portion of the lid section 7. The lid section 7 is mounted on the disposing section 6 from the upper side by screwing mounting screws 60 in the screw threading holes 7b, into the fitting holes 9b.

The window supporting section 4 is formed in a tubular shape with its axial direction in the up-and-down direction and includes a fitting section 11, a holding section 12, and a receiving section 13. In the window supporting section 4, the fitting section 11, the holding section 12, and the receiving section 13 are formed integrally, for example. The fitting section 11 and the holding section 12 are both formed in a cylindrical shape, and the diameter of the fitting section 11 is larger than the diameter of the holding section 12. The holding section 12 is provided in continuity with a lower end portion of the fitting section 11 on the lower side of the fitting section 11. The upper surface of the holding section 12 is formed as a pressed surface 12a, and the lower surface of the same is formed as a distal end surface 12b. In the window supporting section 4, the fitting section 11 is attached to the lower end part of the shaft 5 in an externally fitted manner, and the pressing surface 5a of the shaft 5 is pressed against the pressed surface 12a of the holding section 12.

The receiving section 13 is provided in a state of projecting inward at the vertically intermediate part of the holding section 12 (see FIG. 2). The upper surface of the receiving section 13 is formed as a first receiving surface 13a, and the lower surface of the same is formed as a second receiving surface 13b. The space inside the receiving section 13 is formed as a transmission hole 14. The diameter of the transmission hole 14 is set to be equal to or larger than the diameter of an optical fiber described later.

The space above the receiving section 13 in the internal space of the holding section 12 is formed as a first insertion space 15, and the space below the receiving section 13 is formed as a second insertion space 16. Of an inner circumference surface of the holding section 12, a section forming the first insertion space 15 is formed as a first inner circumference surface 12c, and a section forming the second insertion space 16 is formed as a second inner circumference surface 12d. The first insertion space 15 and the second insertion space 16 are in communication with each other via a transmission hole 14.

A sleeve material 17 and a protective window 18 are arranged in the second insertion space 16.

The sleeve material 17 is formed in a cylindrical shape with its axial direction in the up-and-down direction. The sleeve material 17 is made of a material having a thermal expansion coefficient smaller than that of the window supporting section 4, such as Kovar. The sleeve material 17 is desirably made of a material having a thermal expansion coefficient close to that of the protective window 18.

Almost the entire sleeve material 17 is inserted into the second insertion space 16 such that its upper surface is in contact with the second receiving surface 13b, and its lower surface is positioned on the same plane as the distal end surface 12b of the holding section 12 or slightly below the distal end surface 12b. When the sleeve material 17 is inserted into the second insertion space 16, its outer circumference surface 17a is in contact with the second inner circumference surface 12d of the holding section 12. The sleeve material 17 is bonded to the holding section 12 by welding, for example. However, the sleeve material 17 and the holding section 12 may be bonded by brazing, a heat-resistant adhesive, or the like.

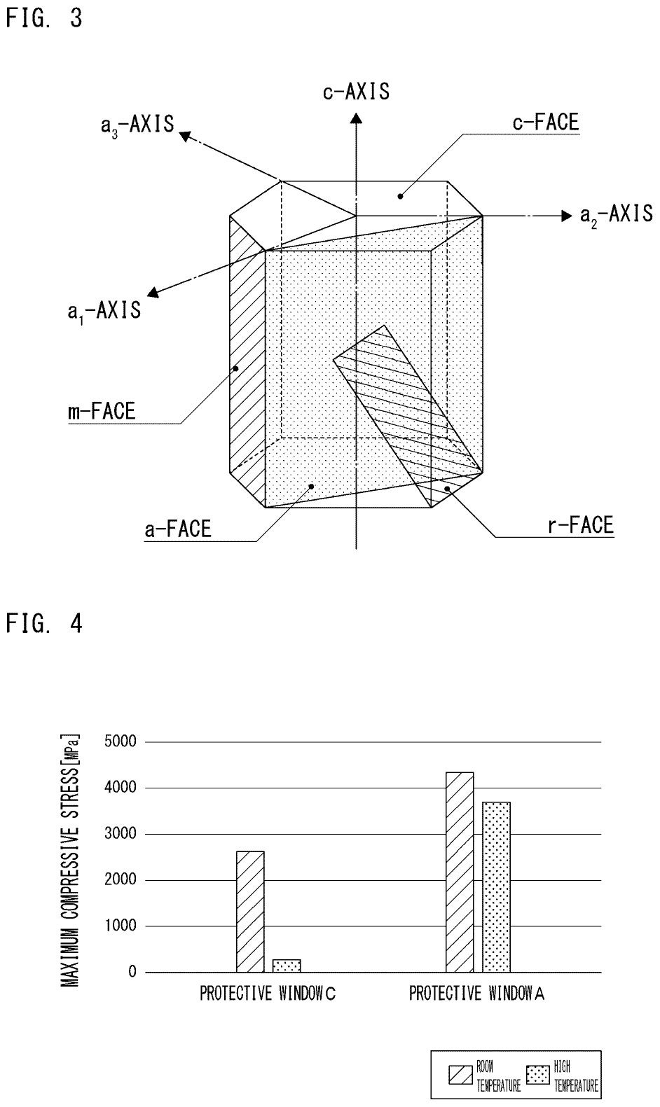

The protective window 18 is formed in a cylindrical shape with its axial direction in the up-and-down direction, its lower surface is formed as a first surface 18a, and its upper surface is formed as a second surface 18b. The first surface 18a and the second surface 18b are substantially parallel to each other. The protective window 18 is made of sapphire, for example. As illustrated in FIG. 3, sapphire has crystal faces such as c-face, m-face, a-face, and r-face with the c-axis as the growth axis, and the first surface 18a and the second surface 18b are a-faces out of the crystal faces of sapphire. The protective window 18 may be chamfered at the continuous section between an outer circumference surface 18c and the first surface 18a.

The outer diameter of the protective window 18 is larger than the diameter of the transmission hole 14 and is substantially the same as or slightly smaller than the inner diameter of the sleeve material 17 (see FIG. 2). The protective window 18 is inserted into the sleeve material 17 and attached to the window supporting section 4 with the outer periphery of the second surface 18b in contact with the second receiving surface 13b. The outer circumference surface 18c of the protective window 18 is bonded to the inner circumference surface 17b of the sleeve material 17 by brazing with silver solder, for example. However, the sleeve material 17 and the protective window 18 may be bonded by low-melting point glass, a heat-resistant adhesive, or the like.

When attached to the window supporting section 4, the protective window 18 has the lower end portion protruding downward from the sleeve material 17. This makes it difficult for molten resin to remain at the distal end portion when the optical temperature sensor 1 is attached to a molding machine such as an injection molding machine and used to measure the temperature of the molten resin.

The thermal expansion coefficient of the protective window 18 is smaller than the thermal expansion coefficient of the window supporting section 4 and larger than the thermal expansion coefficient of the sleeve material 17.

A fiber probe 19 is disposed inside the outer casing 2 (see FIG. 1). The fiber probe 19 is formed of, for example, a metallic material and has a cylindrical section 20 with its axial direction in the up-and-down direction and a brim section 21 continuous with an upper end portion of the cylindrical section 20. The outer diameter of the brim section 21 is greater than the outer diameter of the cylindrical section 20. An upper surface of the brim section 21 is formed as a pressurized surface 21a.

An optical fiber 23 is threaded into and held in the fiber probe 19. The optical fiber 23 has one end section 23a threaded into the cylindrical section 20 and a bent section 23b that is continuous with the one end section 23a and that is bent, for example, at an approximately right angle inside the brim section 21. In the optical fiber 23, a portion between the bent section 23b and another end section is provided as an intermediate section 23c, and the intermediate section 23c is positioned from an outer circumference surface of the brim section 21 to the outside of the fiber probe 19 through the notch 9a. A detector or the like (not illustrated) is connected to the other end section of the optical fiber 23. An end surface (lower end surface) of the one end section 23a of the optical fiber 23 is formed as an incident surface 23d that infrared light enters (see FIG. 2).

The fiber probe 19 is supported by having the cylindrical section 20 inserted through the shaft 5 and the distal end portion inserted into the first insertion space 15 in the holding section 12. The cylindrical section 20 has an outer circumference surface in contact with the first inner circumference surface 12c of the holding section 12, and a distal end surface (lower surface) 19a of the fiber probe in contact with the first receiving surface 13a of the receiving section 13. At this time, the center of the optical fiber 23 (incident surface 23d) is approximately aligned with the center of the transmission hole 14. In this way, the fiber probe 19 is disposed inside the window supporting section 4 in the state where the outer circumference surface of the cylindrical section 20 is in contact with the first inner circumference surface 12c of the holding section 12, thus ensuring a stable condition of disposition without being shaky with respect to the window supporting section 4.

The brim section 21 is positioned in the disposing section 6, and when the lid section 7 is attached to the disposing section 6, an elastic member 22 is disposed between the lower surface of the adjustment screw 10 and the pressurized surface 21a of the brim section 21 (see FIG. 1).

As the elastic member 22, for example, a compression coil spring is used. The fiber probe 19 is biased downward by the biasing force of the elastic member 22. Therefore, the distal end surface 19a of the fiber probe 19 is pressed against the first receiving surface 13a of the receiving section 13 by the biasing force of the elastic member 22. Note that a disc spring, a plate spring, or the like may be used as the elastic member 22, and the elastic member 22 may be formed of a rubber material or the like.

In the optical temperature sensor 1, the biasing force of the elastic member 22 against the fiber probe 19 can be adjusted by rotating the adjustment screw 10 to change its screwed position with respect to the screw hole 7a. The optical temperature sensor 1 may also be configured without providing the elastic member 22.

When the optical temperature sensor 1 configured as described above is attached to a molding machine such as an injection molding machine and used to measure the temperature of molten resin, infrared light emitted from the object to be measured enters the protective window 18 through the first surface 18a, is guided inside the protective window 18, and exits from the second surface 18b. The infrared light having exited from the second surface 18b passes through the transmission hole 14 and enters the optical fiber 23 through the incident surface 23d, and is transmitted to the detector via the optical fiber 23.

In the optical temperature sensor in which infrared light is transmitted through the protective window and incident on the optical fiber, when an air layer exists between the protective window and the incident surface, the light may be reflected at an interface between the protective window and the air layer or an interface between the air layer and the incident surface depending on the conditions of the air layer or the like, which may cause optical interference. Such optical interference occurs when the thickness of the air layer is extremely small, on the order of nanometers to micrometers, and if the thickness of the air layer changes due to, for example, thermal expansion of the protective window, the degree of optical interference also changes, which may affect the results of measurement by the optical temperature sensor.

In the optical temperature sensor 1 described above, since the receiving section 13 is provided in the window supporting section 4, a certain distance is maintained between the upper surface of the protective window 18 and the incident surface 23d of the optical fiber 23 with an air layer (transmission hole 14) interposed therebetween. Since the receiving section 13 is a structural object, the thickness of the air layer is not on the order of nanometers or micrometers but on the order of millimeters or more. Therefore, the receiving section 13 maintains a certain distance or more between the optical fiber 23 and the protective window 18, thereby suppressing the occurrence of optical interference and ensuring a stable measurement state.

In addition, the first receiving surface 13a of the receiving section 13 contacts the fiber probe 19, and the second receiving surface 13b contacts the protective window 18. Accordingly, the biasing force of the elastic member 22 applied to the fiber probe 19 is unlikely to be transmitted to the protective window 18, and if the pressure of the molten resin is applied to the protective window 18, the pressure of the molten resin is transmitted from the protective window 18 to the outer casing 2 via the receiving section 13, thereby reducing the load on the protective window 18 due to the pressure of the molten resin.

Furthermore, in the optical temperature sensor 1, the sleeve material 17 is provided between the protective window 18 and the window supporting section 4. This suppresses intrusion of the molten resin between the protective window 18 and the window supporting section 4, making it difficult for excessive radial force to be applied to the protective window 18.

Since the protective window 18 is formed of sapphire glass and the sleeve material 17 is formed of Kovar, the thermal expansion coefficient of the sleeve material 17 is smaller than but close to the thermal expansion coefficient of the protective window 18, and the degrees of expansion of the protective window 18 and the sleeve material 17 are similar. Therefore, the protective window 18 is slightly clamped by the sleeve material 17 during expansion, which further prevents intrusion of the molten resin between the protective window 18 and the sleeve material 17.

### <Test Results for Pressure Resistance>

The test results for the pressure resistance of the protective window will be described below (see FIG. 4).

In the pressure resistance test, the maximum compressive stress of a cylindrical protective window made of sapphire was measured in the axial direction. In the test, two protective windows, a protective window A in which both axial side surfaces (first and second surfaces) are a-faces and a protective window C in which both axial side surfaces are c-faces, were used and their maximum compressive stresses were measured after 10-minute compression in atmospheres of a room temperature (21.9° C.) and a high temperature (450° C.).

As illustrated in FIG. 4, the maximum compressive stress of the protective window C was significantly reduced in the high temperature atmosphere compared to the room temperature atmosphere. On the other hand, the reduction in the maximum compressive stress of the protective window A in the high temperature atmosphere compared to the room temperature atmosphere was smaller than that of the protective window C.

From the above measurement results, it was confirmed that setting the first and second surfaces of the protective window as a-faces of sapphire ensures high pressure resistance against axial pressure in a high temperature environment.

### <Optical Temperature Sensor According to Second Embodiment>

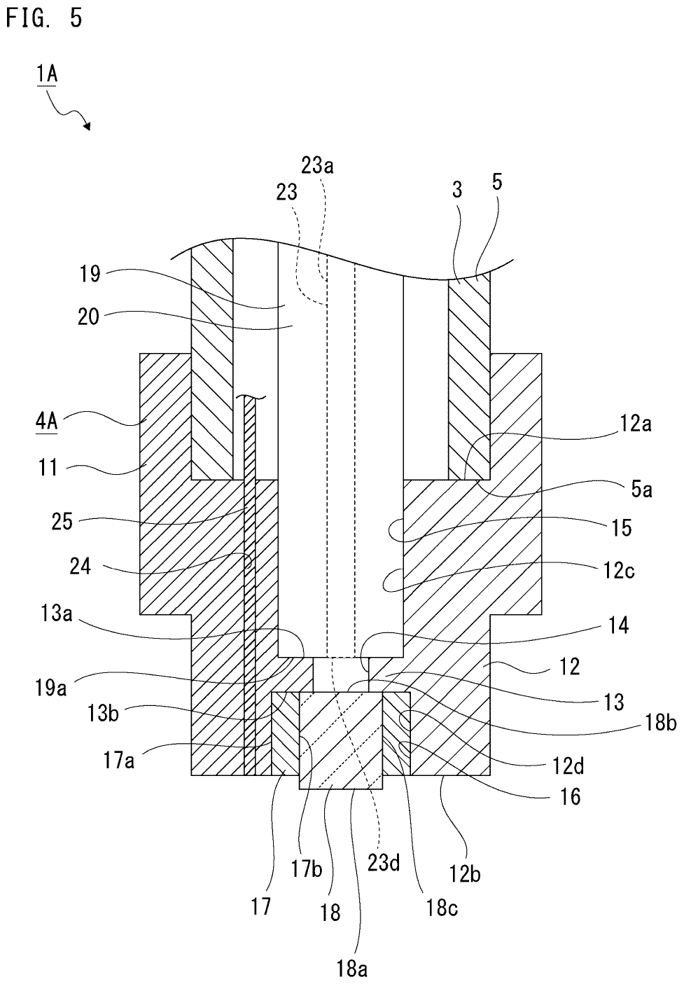

Next, an optical temperature sensor 1A according to a second embodiment will be described (see FIG. 5).

In each of the embodiments described below, only the sections that are different from those of the previously described embodiments will be described in detail, and the other parts will be given the same reference numerals as those given to similar parts in the previously described embodiments, and descriptions thereof will be omitted.

The optical temperature sensor 1A is provided with a window supporting section 4A instead of the window supporting section 4.

The window supporting section 4A has a calibration insertion hole 24 that penetrates a holding section 12 from top to bottom. A calibration optical temperature sensor, for example, a thermocouple 25, is inserted into the calibration insertion hole 24. As the thermocouple 25, a sheath-type thermocouple is used, for example. The thermocouple 25 is attached by welding to the window supporting section 4A with one end inserted into the calibration insertion hole 24. The other end of the thermocouple 25 is taken out to the outside of an outer casing 2 through a notch 9a, for example, and is connected to a measuring instrument or the like (not illustrated).

As described above, in the optical temperature sensor 1A, the window supporting section 4A has the calibration insertion hole 24 formed therein, and the thermocouple 25 is attached to the calibration insertion hole 24. Accordingly, temperature measurement is performed using both an optical fiber 23 and the thermocouple 25, so that it is possible to calibrate the measurement results and improve the measurement accuracy of the optical temperature sensor 1A.

### <Optical Temperature Sensor According to Third Embodiment>

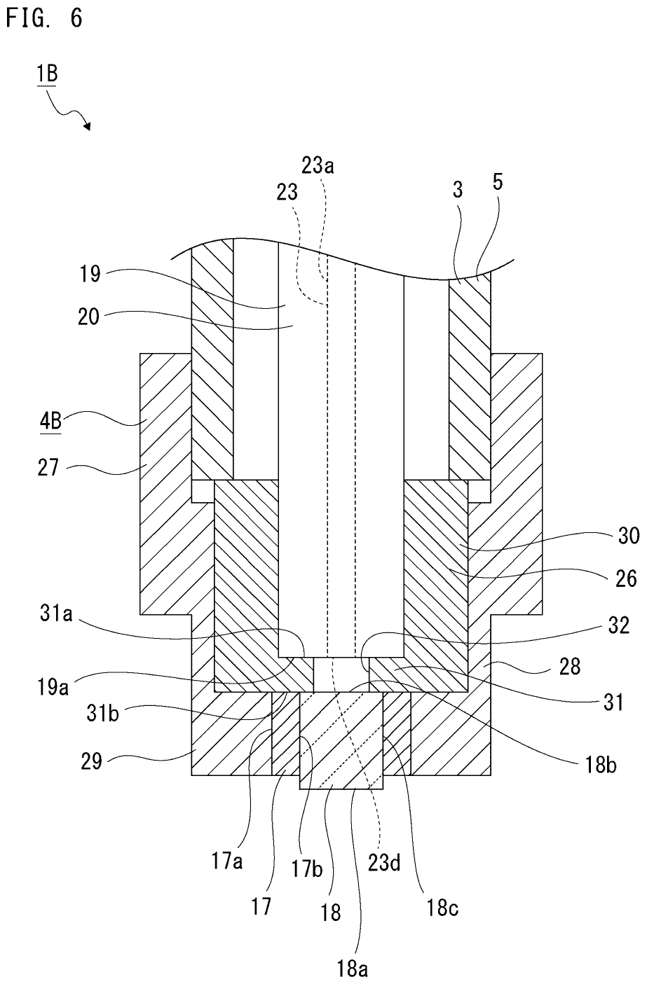

Next, an optical temperature sensor 1B according to a third embodiment will be described (see FIG. 6).

The optical temperature sensor 1B is provided with a window supporting section 4B instead of the window supporting section 4, and a spacer 26.

The window supporting section 4B has a fitting section 27, a coupling section 28, and a holding section 29. The fitting section 27, the coupling section 28, and the holding section 29 are all formed in a cylindrical shape. The coupling section 28 is provided continuous with the lower end of the fitting section 27, and the holding section 29 is provided continuous with the lower end of the coupling section 28. A sleeve material 17 and a protective window 18 are inserted into and supported by the holding section 29.

The spacer 26 is also supported by the window supporting section 4B. The spacer 26 is formed from a metal material, for example, and has a cylindrical tubular section 30 with its axial direction in the up-and-down direction, and a receiving section 31 that protrudes inward from the lower end of the tubular section 30. The upper surface of the receiving section 31 is formed as a first receiving surface 31a, and the lower surface of the same is formed as a second receiving surface 31b. The space inside the receiving section 31 is formed as a transmission hole 32. The tubular section 30 and the receiving section 31 are formed integrally, for example.

The distal end of a fiber probe 19 is inserted into the tubular section 30, the outer circumference surface of the cylindrical section 20 is in contact with the inner circumference surface of the tubular section 30, and a distal end surface 19a of the fiber probe is in contact with the first receiving surface 31a of the receiving section 31. The upper surface of the sleeve material 17 and the upper surface of the protective window 18 are in contact with the second receiving surface 31b of the receiving section 31.

As described above, the optical temperature sensor 1B is provided with the spacer 26. This makes it difficult for the biasing force of an elastic member 22 applied to the fiber probe 19 by the receiving section 31 to be transmitted to the protective window 18, and also transmits the pressure of the molten resin from the protective window 18 to the outer casing 2 via the spacer 26.

In addition, providing the receiving section 31 as a separate body from the window supporting section 4B makes it possible to form the receiving section 31 from a material different from that of the window supporting section 4B. For example, forming the spacer 26 from a material that is stronger than the window supporting section 4B makes it possible to ensure the high strength of the receiving section 31.

### <Optical Temperature Sensor According to Fourth Embodiment>

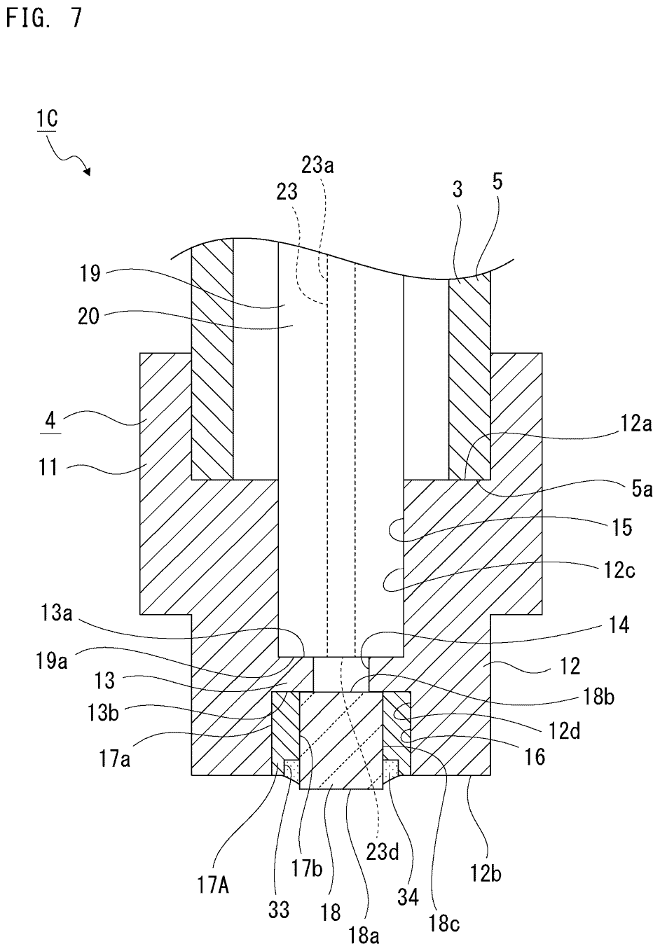

Next, an optical temperature sensor IC according to a fourth embodiment will be described (see FIG. 7).

In the optical temperature sensor 1C, a sleeve material 17A and a protective window 18 are disposed in a second insertion space 16 in a window supporting section 4.

A recess 33 that is open downward and inward is formed around the entire circumference at the lower end of the sleeve material 17A, for example. With the protective window 18 inserted into the sleeve material 17A, the recess 33 is filled with a sealant 34, and the sealant 34 is baked to fix the protective window 18 to the sleeve material 17A.

As the sealant 34, frit glass (bismuth-based glass, alumina-based glass, borosilicate glass, or the like) is used, for example. As the sealant 34, it is necessary to select a material that will not deform at the temperature of the environment in which the optical temperature sensor 1C is used. For example, a material with a softening point higher than the temperature of the environment in which the optical temperature sensor 1C is used is desirable.

However, in a case where no recess is formed in the sleeve material or where the protective window is attached to the window supporting section without a sleeve material as in the optical temperature sensor described in Patent Document 2, if a sealant is applied to the boundary between the protective window and the window supporting section or the sleeve material and then baked, the sealant may spread to an unintended range during baking, resulting in an insufficient seal between the protective window and the window supporting section or the sleeve material, so that the molten resin may intrude into the inside of the optical temperature sensor. In addition, if the sealant is baked in a state of spreading to the first surface of the protective window, this may result in a decrease in measurement accuracy.

As described above, in the optical temperature sensor 1C, the sleeve material 17A has the recess 33 formed to be filled with the sealant 34. This allows the sealant 34 to be baked within the desired range without spreading to unintended areas, ensuring a good sealing state between the sleeve material 17A and the protective window 18 by the sealant 34 and preventing intrusion of the molten resin into the optical temperature sensor. In addition, the sealant 34 is unlikely to reach a first surface 18a of the protective window 18, ensuring a good measurement state of the optical temperature sensor 1C.

The above-described structure for fixing the protective window to the sleeve material is also effective for a protective window whose first surface is a crystal face other than an a-face of sapphire.

### SUMMARY

As described above, in the optical temperature sensors 1, 1A, 1B, and 1C, the protective window 18 is made of sapphire, and the first surface 18a of the protective window 18 is the a-face of sapphire. Accordingly, the maximum compressive stress of the protective window 18 is unlikely to decrease in a high-temperature environment compared to that in a normal temperature environment, so that it is possible to ensure high pressure resistance of the protective window 18 in a high-temperature environment and prevent damage to the protective window 18 due to pressure during measurement.

The second surface 18b is also an a-face of sapphire.

Sapphire is a uniaxial crystal with the c-axis as its optical axis, and has the optical property of producing birefringence in light incident from a direction at an angle to the c-axis. Setting both the first surface 18a and the second surface 18b of sapphire as a-faces as described above suppresses the effect of birefringence on the infrared light guided by the protective window 18 toward the optical fiber 23 (incident surface 23d), so that the high pressure resistance of the protective window 18 can be ensured without causing a decrease in the measurement accuracy of the optical temperature sensor 1.

As described above, the optical temperature sensor 1 can ensure favorable measurement conditions even in high-temperature and high-pressure environments, and is therefore suitable for use in molding machines where the measurement environment tends to be high in temperature and pressure.

What is claimed is:

1. An optical temperature sensor comprising:
a tubular fiber probe into which an optical fiber is threaded; and
a protective window formed of sapphire and positioned on a distal end side of the fiber probe, wherein
a surface of the protective window opposite to the optical fiber in an axial direction of the fiber probe is formed as a first surface, and a surface of the protective window facing the optical fiber is formed as a second surface, and
the first surface is an a-face of sapphire.

2. The optical temperature sensor according to claim 1, wherein the second surface is an a-face of sapphire.

3. The optical temperature sensor according to claim 1, used in a molding machine.

4. The optical temperature sensor according to claim 1, further comprising
a window supporting section formed in a cylindrical shape and into which at least a part of the protective window is inserted, wherein
a calibration insertion hole is formed in the window supporting section, and
a thermocouple is inserted into the calibration insertion hole.
